(19) United States
(12) Patent Application Publication
(10) Pub. No.: US 2009/0268693 A1
(43) Pub. Date: Oct. 29, 2009

(54) Signaling part of semi-persistent configuration via downlink control channel

(75) Inventors: Lars E. Lindh, Helsingfors (FI); Esa M. Malkamaki, Espoo (FI); Jussi K. Ojala, Helsinki (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/150,333

(22) Filed: Apr. 25, 2008

(51) Int. Cl. H04J 3/00; H04Q 7/20

(52) U.S. Cl. 370/336; 370/329

(57) ABSTRACT

A method includes receiving a first control information from a network access node, the first control information comprising a plurality of fields defining control information elements that are relevant to a resource allocation; receiving a second control information from the network access node, the second control information comprising a plurality of fields defining control information elements that are relevant to the resource allocation; and declaring the resource allocation to be a persistent resource allocation if at least one of the plurality of fields of the second control information is the same as one of the plurality of fields of the first control information. Also disclosed are computer programs and apparatus for carrying out the method, as well as a network access node configured to compose first control information and second control information for expressing resource allocations.

### TECHNICAL FIELD

The exemplary and non-limiting embodiments of this invention relate generally to wireless communication systems, methods, devices and computer programs and, more specifically, relate to techniques to signal resource allocation configurations from a network access node to a user equipment.

### BACKGROUND

Various abbreviations that appear in the specification and/or in the drawing figures may be defined as follows:
3GPP third generation partnership project
UTRAN universal terrestrial radio access network
EUTRAN evolved UTRAN (LTE)
LTE long term evolution
Node B base station
eNB EUTRAN Node B (evolved Node B)
UE user equipment
UL uplink (UE towards eNB)
DL downlink (eNB towards UE)
EPC evolved packet core
MME mobility management entity
S GW serving gateway
MM mobility management
HO handover
C-RNTI cell radio network temporary identifier
PDU protocol data unit
PRB physical resource block
PHY physical
SN sequence number
RB radio bearer
RLC radio link control
RRC radio resource control
RRM radio resource management
MAC medium access control
PDCP packet data convergence protocol
O&M operations and maintenance
CDM code division multiplexing
FDD frequency division duplex
FDMA frequency division multiple access
HARQ hybrid automatic repeat request
ACK acknowledgement
NACK not (negative) acknowledgement
OFDMA orthogonal frequency division multiple access
SC-FDMA single carrier, frequency division multiple access
TDD time division duplex
TTI transmission time interval
PDCCH physical downlink control channel
PHICH physical hybrid automatic repeat request indicator channel
SID silence descriptor
DCI downlink control information

A proposed communication system known as evolved UTRAN (E-UTRAN, also referred to as UTRAN LTE or as E UTRA) is currently under development within the 3GPP. The current working assumption is that the DL access technique is OFDMA, and the UL access technique is SC-FDMA.

One specification of interest is 3GPP TS 36.300, V8.3.0 (2007 12), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), incorporated by reference herein in its entirety.

FIG. 1A reproduces FIG. 4 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1-MME interface and to a Serving Gateway (S-GW) by means of a S1-U interface. The S1 interface supports a many-to-many relation between MMEs/Serving Gateways and eNBs.

The eNB hosts the following functions:
functions for Radio Resource Management: Radio Bearer Control, Radio Admission Control, Connection Mobility Control, Dynamic allocation of resources to UEs in both uplink and downlink (scheduling);
IP header compression and encryption of user data stream;
selection of a MME at UE attachment;
routing of User Plane data towards Serving Gateway;
scheduling and transmission of paging messages (originated from the MME);
scheduling and transmission of broadcast information (originated from the MME or O&M); and
measurement and measurement reporting configuration for mobility and scheduling.

In those wireless communication systems where the control channel resources are limited various techniques to optimize the use of the control channel resources have been considered. One optimization technique is to use a persistent or semi-persistent allocation of transmission resources. In this technique resources are assigned for transmission in the DL or UL for a period longer than for a normal (one time) allocation. For example, in the LTE system it has been agreed that semi-persistent scheduling is to be accommodated by the system specification. In that the periodicity pattern of transmission/reception resources are assigned to the UE with higher layer signaling (e.g., RRC signaling) then the UE is enabled to transmit and/or receive in the assigned resources without explicit L1/L2 control signaling (i.e., without the use of the PDCCH).

An example is shown in FIG. 2, where “talk-spurt based” semi-persistent allocation is described for a VoIP connection. The RRC signaling is used to assign a 20 ms periodicity pattern to the UE. Afterwards, when the traffic is identified in the beginning of the talk-spurt, the time and frequency resources and TFI are assigned to the UE with L1/L2 control signaling (i.e., with the PDCCH). The UE stores the time and frequency resources and TFI information, and this information informs the UE that it can either transmit (UL) or receive (DL) the assigned format of packets with these resources using the known periodicity pattern (signaled via the RRC). As can be noted in FIG. 2, the re-transmissions in the DL are sent using L1/L2 control signaling as the semi-persistent scheduling is typically only applied for the initial transmission (not for re transmissions if needed).

One requirement for such talk-spurt based semi-persistent scheduling is that the PDCCH that is used for allocating the time and frequency resources for semi-persistent use must be reliable. A problem of false positive detection for triggering a semi-persistent allocation can be particularly troublesome, since the UE blindly decodes the PDCCH and may determine that it received a semi-persistent allocation, even though it may have only received random bits. With the use of a 16 bit CRC it can be shown that this error case can arise in every 2¹⁶=65,536 blind decoding operations. In a worst case scenario there could be as many as 40 blind decoding operations per TTI (1 ms) and per UE, meaning that a failure to correctly receive the PDCCH could occur once in every 1.6 seconds. Although the use of DRX and the UL/DL split can somewhat alleviate this problem it can still be severe. It can be particularly problematic if the false detection by the UE results in an (erroneous) persistent UL transmission, which could potentially render the entire BW unusable for other UEs in the cell. This problem is further aggravated by the fact that the eNodeB is not aware of the problem and hence has no means of turning the erroneous transmission off.

The conventional approach of semi-statically configuring UEs to use different frequency resources for persistent scheduling is thus inadequate, and can result in serious problems during operation of the wireless communication network.

### SUMMARY

The foregoing and other problems are overcome, and other advantages are realized, by the use of the exemplary embodiments of this invention.

In a first aspect thereof the exemplary embodiments of this invention provide a method that includes receiving a first control information from a network access node, the first control information comprising a plurality of fields defining control information elements that are relevant to a resource allocation; receiving a second control information from the network access node, the second control information comprising a plurality of fields defining control information elements that are relevant to the resource allocation; and declaring the resource allocation to be a persistent resource allocation if at least one of the plurality of fields of the second control information is the same as one of the plurality of fields of the first control information.

In another aspect thereof the exemplary embodiments of this invention provide a computer readable medium that stores program instructions, where execution of the program instructions results in performance of operations that include receiving a first control information from a network access node, the first control information comprising a plurality of fields defining control information elements that are relevant to a resource allocation; receiving a second control information from the network access node, the second control information comprising a plurality of fields defining control information elements that are relevant to the resource allocation; and declaring the resource allocation to be a persistent resource allocation if at least one of the plurality of fields of the second control information is the same as one of the plurality of fields of the first control information.

In another aspect thereof the exemplary embodiments of this invention provide an apparatus that includes a controller coupled with a wireless transmitter, a wireless receiver and a memory. The controller is configured to receive a first control information from a network access node, the first control information comprising a plurality of fields defining control information elements that are relevant to the resource allocation. The controller is further configured to receive a second control information from the network access node, the second control information also comprising a plurality of fields defining control information elements that are relevant to the resource allocation. The controller is further configured to declare the resource allocation to be a persistent resource allocation if at least one of the plurality of fields of the second control information is the same as one of the plurality of fields of the first control information, and to store in the memory control information elements received with the second resource allocation for use during the persistent resource allocation.

In a further aspect thereof the exemplary embodiments of this invention provide a method that includes composing a first control information for a user equipment, the first control information comprising a plurality of fields defining control information elements that are relevant to a resource allocation; transmitting the first control information to the user equipment; composing a second control information for the user equipment, the second control information comprising a plurality of fields defining control information elements that are relevant to the resource allocation, where the resource allocation is made to be a persistent resource allocation by making at least one of the plurality of fields of the second control information to be the same as one of the plurality of fields of the first control information and transmitting the second control information to the user equipment.

In a still further aspect thereof the exemplary embodiments of this invention provide an apparatus that includes a wireless transmitter; a wireless receiver; a memory; and a controller coupled with the wireless transmitter, the wireless receiver and the memory, said controller configured to compose and transmit a first control information for a user equipment, the first control information comprising a plurality of fields defining control information elements that are relevant to a resource allocation, said controller being further configured to compose and transmit a second control information for the user equipment, the second control information comprising a plurality of fields defining control information elements that are relevant to the resource allocation, where the resource allocation is made to be a persistent resource allocation by making at least one of the plurality of fields of the second control information to be the same as one of the plurality of fields of the first control information.

### BRIEF DESCRIPTION OF THE DRAWINGS

In the attached Drawing Figures:

FIG. 1A reproduces FIG. 4 of 3GPP TS 36.300, and shows the overall architecture of the E-UTRAN system.

FIG. 1B reproduces FIG. 5.2.1 1 of 3GPP TS 36.211 and shows an UL resource grid, including a physical resource block.

FIG. 1C reproduces Table 5.2.3 1 of 3GPP TS 36.211 and shows resource block parameters.

FIG. 2 shows an example of talk spurt based semi-persistent scheduling.

FIG. 3 shows a simplified block diagram of various electronic devices that are suitable for use in practicing the exemplary embodiments of this invention.

FIG. 4 shows an example of semi-persistent allocation of the UL for a VoIP connection in accordance with the exemplary embodiments of this invention.

FIG. 5 shows an example of a semi-persistent allocation for the case of UL VoIP packet traffic in accordance with the exemplary embodiments of this invention.

FIG. 6 is a logic flow diagram that illustrates the operation of a method, and a result of execution of computer program instructions, in accordance with the exemplary embodiments of this invention.

FIG. 7 is a logic flow diagram that illustrates the operation of a further method, and a result of execution of computer program instructions, in accordance with the exemplary embodiments of this invention.

### DETAILED DESCRIPTION

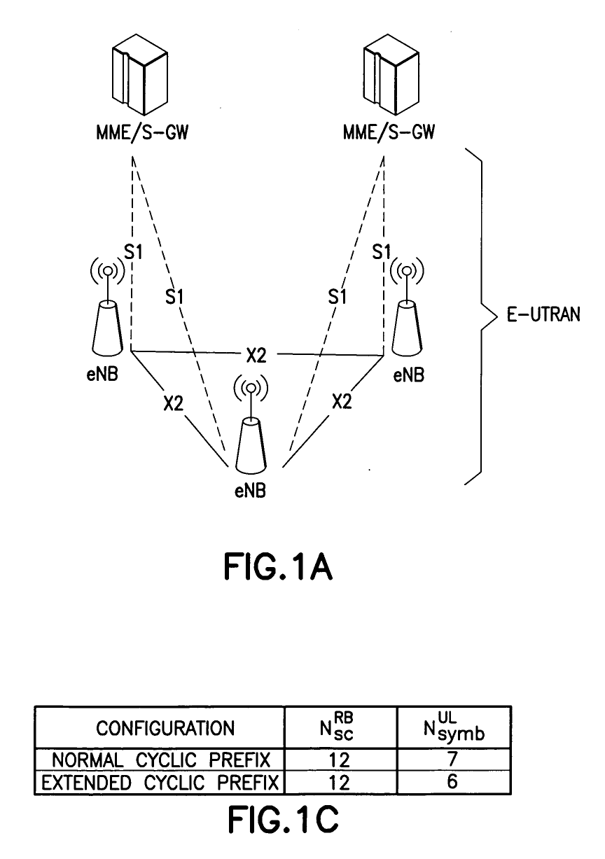

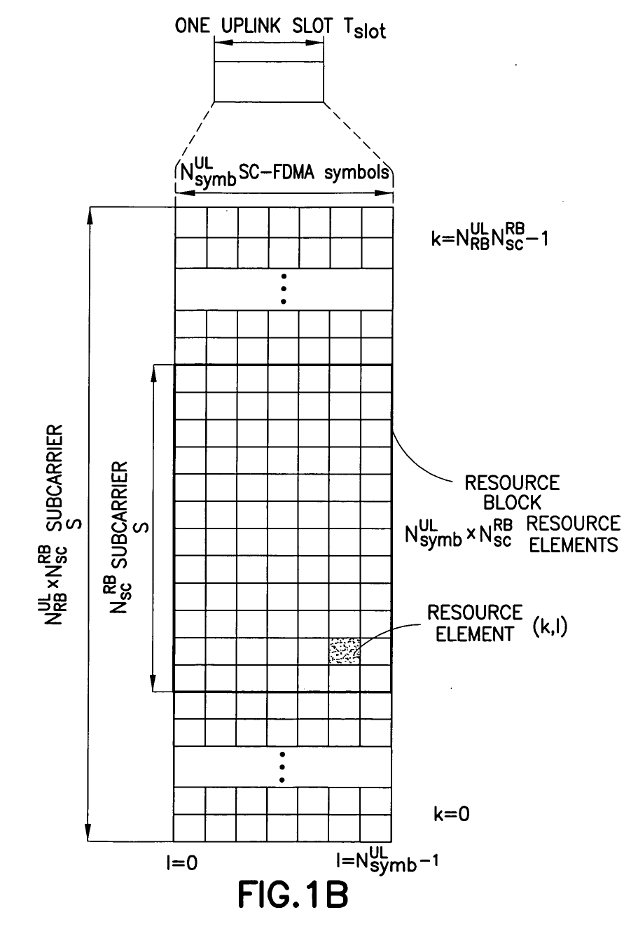

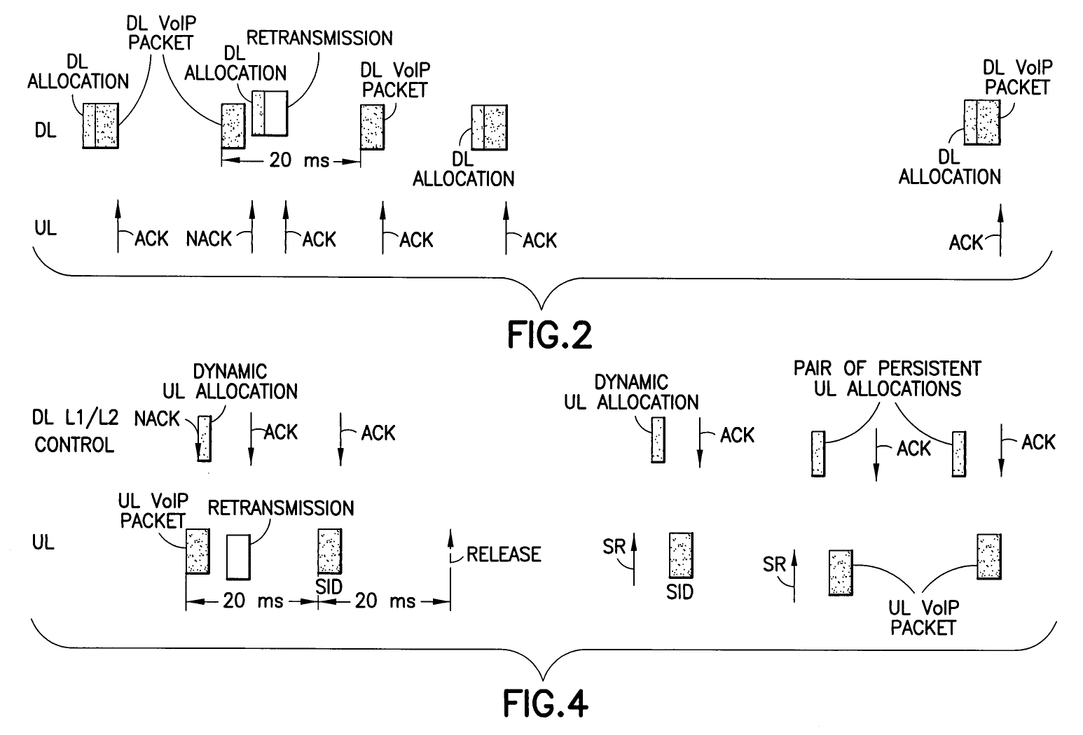

Reference is made to FIG. 3 for illustrating a simplified block diagram of various electronic devices that are suitable for use in practicing the exemplary embodiments of this invention. In FIG. 3 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include the MME/S GW functionality shown in FIG. 1, and which provides connectivity with a network 16, such as a telephone network and/or a data communications network (e.g., the internet). The UE 10 includes a data processor (DP) 10A, a memory (MEM) 10B that stores a program (PROG) 10C, and a suitable radio frequency (RF) transceiver 10D for bidirectional wireless communications 11 with the eNB 12 via one or more antennas. The eNB 12 also includes a DP 12A, a MEM 12B that stores a PROG 12C, and a suitable RF transceiver 12D. The eNB 12 is coupled via a data path 13 to the NCE 14. The data path 13 may be implemented as the S1 interface shown in FIG. 1A. At least one of the PROGs 10C and 12C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNB 12, or by hardware, or by a combination of software and hardware.

For the purposes of describing the exemplary embodiments of this invention the UE 10 may be assumed to also include a resource allocation reception unit (RARU) 10E, a codec 10F for use with an exemplary VoIP application, a MAC function or unit 10G, a timer 10H (typically part of the MAC function 10G), and a RRC function or unit 10I. In practice, the timer 10H may be set to indicate predetermined amount of time using a timer value received from RRC signaling. The eNB 12 includes a resource scheduler function (SCHED) 12E, as well as MAC and RRC (and higher protocol layer) functions or units 12F, 12G. Note that the resource scheduler function 12E may be a part of the eNB 12 MAC function 12F. The eNB 12 is assumed to be capable of composing and transmitting control information to the UE 10, which is assumed to be capable of receiving and interpreting the received control information, as described in detail below.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multicore processor architecture, as non-limiting examples.

As used herein the phrases “persistent resource” allocation and scheduling and “semi-persistent” resource allocation and scheduling may be considered as being substantially equivalent, that is, to refer to a resource allocation that is meant to be used over a period of time for transmitting more than one data unit, such as more than one VoIP packet.

Turning now to a more detailed explanation of the exemplary embodiments of this invention, it has been agreed that the persistent scheduling is configured by RRC signaling, i.e., the persistent scheduling feature is turned on/off by RRC signaling, and the periodicity of the persistent scheduling (e.g., PS_PERIOD) is also given by RRC signaling. The specific timing information, as well as the allocated resources and transport format parameters, are sent on the L1/L2 control channel (on the PDCCH) as a normal UL grant. If the UL grant is missed (there is no resulting UL transmission), the eNB 12 can resend the UL grant.

In a manner that is compatible with the foregoing agreement, the exemplary embodiments of this invention provide a technique to reduce the probability of an occurrence of a false positive to an acceptable level by sending the persistent UL grant on the PDCCH two times, and the UE 10 is allowed to transmit on the UL using the persistent parameters only after receiving two identical persistent allocations. In effect, this procedure may be viewed as doubling the CRC length to 32 bits. Since the content of the two allocations needs to be identical in order to be accepted by the RARU 10E of the UE 10, the probability of an occurrence of a false positive is essentially reduced to zero.

It may appear at first glance that the use of these exemplary embodiments would increase the delay of starting the use of the persistent allocation, and furthermore that usage of the PDCCH is increased. However, this is not actually the case, as explained below.

At the beginning of the talk-spurt the UE 10 MAC function 10G detects that there is a speech packet arriving from the codec 10F, and that the UE 10 should send an uplink scheduling request (SR) to the eNB 12. The SR is sent on a dedicated resource (D-SR). For the exemplary VoIP application that is considered herein one may assume that the SR resource is available at least every 10 ms. The scheduler 12E of the eNB 12 sends the UE 10 a first persistent uplink grant (a tentative persistent UL grant) by sending a L1/L2 UL grant which indicates that the persistent UL grant should be stored. This first persistent UL grant may be considered as first control information containing control information elements. The UE 10 stores the received persistent parameters in the memory 10B, while also interpreting the allocation as a dynamic one-time allocation, and then sends the VoIP packet using the received UL parameters (control information elements). After receiving the first packet, the eNB 12 knows that persistent allocation is actually needed and sends the second persistent UL grant of the persistent UL grant pair. This second persistent UL grant may be considered as second control information also containing control information elements. When the UE 10 receives the second persistent UL grant, containing a resource allocation that may be identical to the resource allocation of the first persistent UL grant, the UE 10 is granted permission to use the allocated parameters persistently. If the second persistent UL grant is not received, then the UE 10 discards the stored parameters (e.g., after PS_PERIOD).

Once the UE 10 has the persistent allocation there is normally no need to send a SR. As has been previously agreed, the UE 10 monitors the L1/L2 control channel in preconfigured TTIs (DRX), and if no valid UL allocation is given to the UE 10, the UE 10 is allowed to send an initial data transmission using the persistent resource (using a stored transport format). The retransmissions are allocated using the L1/L2 control channel, or they may be allocated in a non-adaptive manner by sending a NAK on the PHICH.

With this technique any SID (silence descriptor) frames may also be allocated “persistently”. That is, when receiving a SR for a SID frame (note that the eNB 12 does not know whether the frame to be transmitted by the UE 10 is a SID frame, or a full VoIP packet, or something else), the eNB 12 may send the first persistent UL grant and, after receiving the SID frame, the eNB need not send the second persistent UL grant. In this case the UE 10 discards the stored parameters of the first allocation, which is treated in this case as a dynamic, one time resource allocation.

In general, the scheduler 12E of the eNB 12 may be considered to compose resource allocations for use by the UE 10, where the resource allocations are composed in accordance with the exemplary embodiments of this invention.

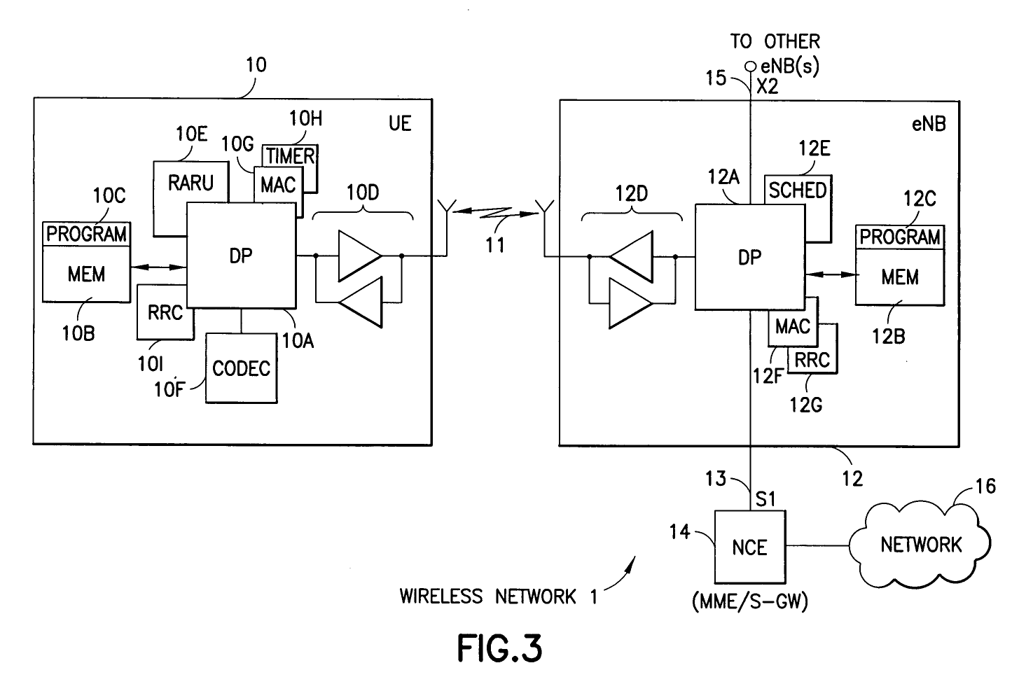

FIG. 4 shows a semi-persistent allocation of the UL for a VoIP connection in accordance with the exemplary embodiments of this invention.

The semi-persistent allocation can be distinguished from a dynamically scheduled allocation in the PDCCH in several different ways. In one exemplary embodiment a different C-RNTI is used than one used with a normal dynamic allocation. The use of two PDCCHs in the same TTI, or in different TTIs, when triggering a semi-persistent allocation has the ability to dramatically decrease the false positive probability.

Further in this regard, and by way of clarification, in the MAC specifications the C-RNTI is the UE 10 ID. The UE 10 can thus have two C-RNTIs associated therewith, one related to dynamic scheduling and another related to semi-persistent scheduling (currently referred to as the Semi-Persistent Scheduling C-RNTI in the MAC specification.

The two PDCCHs (the pair of persistent UL allocations shown in FIG. 4) can be sent in the same TTI, which has the advantage that the persistent allocation can be signaled more rapidly. However, this approach uses more PDCCH resources in one TTI, which may have peak power and/or capacity implications.

Alternatively, the second PDCCH may be sent in the following TTI. This approach avoids any potential peak power and/or capacity issues, and also minimizes the delay, although additional PDCCH resources are still used.

In FIG. 4, the two PDCCHs are sent, one for each separate packet (as described above). Both PDCCHs indicate that they are semi-persistent allocations (e.g., with a specific C-RNTI that is equal to the UE identification). However, the allocation becomes persistent only if certain criteria concerning the PDCCH content and reception time are met. Non-limiting examples of such criteria may include (but are not limited to) the following.

A. The two PDCCHs are sent (exactly) one PS_PERIOD apart, where PS_PERIOD is the periodicity of the semi-persistent allocation, and where the content of both PDCCHs is the same.

B. The two PDCCHs are sent within a given time limit, e.g., PS_PERIOD and the content is the same.

It should be noted that having the PDCCH content the same in both PDCCHs does not require that all of the PDCCH content is identical. Instead, only those fields relevant to the persistent allocation should be the same. Examples of such relevant fields that define what may be considered as relevant resource allocation elements include, for example, transport block size (TBS) or, alternatively, the modulation and coding scheme (MCS) and the physical resource block (PRB) allocation. Note that the definition may be such that if at least one of these is the same: e.g., if the TBS is the same in two semi-persistent PDCCHs received within a predetermined interval of time, then the UL allocation becomes persistent. In this case, all of the relevant parameters from the latter PDCCH are stored for future use, as possibly one or more of them may differ from the parameters sent in the first PDCCH. The UE 10 may also store the TTI number, where the stored UL TTI is equal to the current TTI.

Note further that in the uplink grant a cyclic shift for the UL reference signal may be given, and which may also be considered as being relevant to the persistent allocation. Related to the foregoing, the LTE Layer 1 (PHY) is defined in such a way as to adapt to various spectrum allocations. In general, the PHY layer specification can be found in 3GPP TS 36.213, V8.2.0 (2008-03), 3rd Generation Partnership Project; Technical Specification Group Radio Access Network; Evolved Universal Terrestrial Radio Access (E-UTRA); Physical layer procedures (Release 8), and 3GPP TS 36.211, V8.2.0 (2008-03), 3rd Generation Partnership Project; Technical Specification Group Radio Access Network; Evolved Universal Terrestrial Radio Access (E-UTRA); Physical channels and modulation (Release 8). Reference can also be made to 3GPP TS 36.212 V8.2.0 (2008-03), 3rd Generation Partnership Project; Technical Specification Group Radio Access Network; Evolved Universal Terrestrial Radio Access (E-UTRA); Multiplexing and channel coding (Release 8). These various 3GPP specifications are incorporated by reference herein.

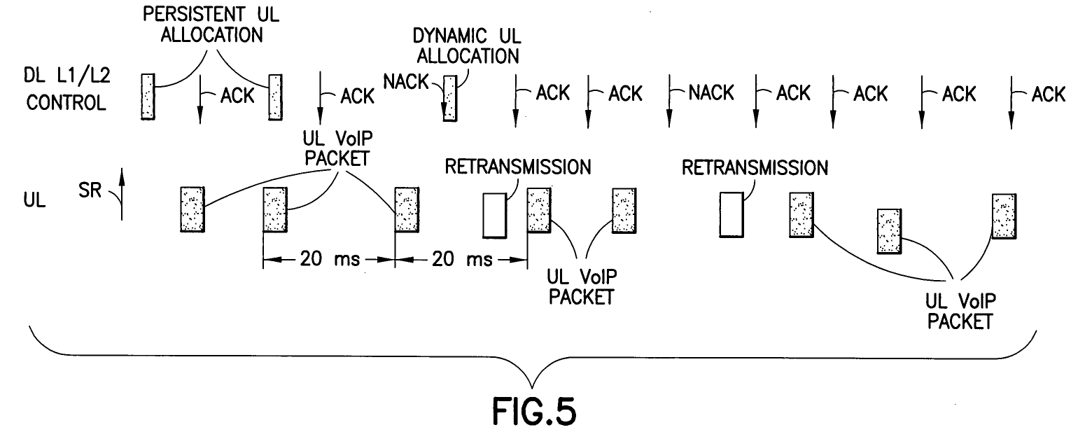

Referring specifically to subclause 5.2 of 3GPP TS 36.211, V8.2.0, “Slot structure and physical resources”, in subclause 5.2.1 a resource grid is shown and described. FIG. 5.2.1 1, reproduced herein as FIG. 1B, shows the UL resource grid as currently defined. The transmitted signal in each slot is described by the resource grid of N_{RB}^{UL}N_{sc}^{RB} subcarriers and N_{symb}^{UL} SC-FDMA symbols. The quantity N_{RB}^{UL} depends on the uplink transmission bandwidth configured in the cell and fulfils the relationship:

N_{RB}^{min,UL}≦N_{RB}^{UL}≦N_{RB}^{max,UL},

where N_{RB}^{min,UL}=6 and N_{RB}^{max,UL}=110 is the smallest and largest UL BW, respectively, supported by the current version of the specification. The set of allowed values for N_{RB}^{UL} is given by 3GPP TS 36.104, Evolved Universal Terrestrial Radio Access (E-UTRA); Base Station (BS) radio transmission and reception.

The number of SC-FDMA symbols in a slot depends on the cyclic prefix length configured by higher layers and is given in Table 5.2.3-1, reproduced herein as FIG. 1C.

As is described in subclause 5.2.2, “Resource elements”, each element in the resource grid is referred to as a resource element and is uniquely defined by the index pair (k,l) in a slot where k=0, . . . , N_{RB}^{UL}N_{sc}^{RB} 1 and l=0, . . . , N_{symb}^{UL} 1 are the indices in the frequency domain and the time domain, respectively. Resource element (k,l) corresponds to the complex value a_{k,l}. Quantities a_{k,l}. corresponding to resource elements not used for transmission of a physical channel or a physical signal in a slot are set to zero.

Subclause 5.2.3, “Resource blocks”, defines a physical resource block as N_{symb}^{UL} consecutive SC-FDMA symbols in the time domain and N_{sc}^{RB} consecutive subcarriers in the frequency domain, where N_{symb}^{UL} and N_{sc}^{RB} are given by Table 5.2.3-1 (FIG. 1C herein). A physical resource block in the UL thus consists of N_{symb}^{UL}×N_{sc}^{RB} resource elements, corresponding to one slot in the time domain and 180 kHz in the frequency domain.

In 3GPP TS 36.212, subclause 5.3.3, Downlink control information (DCI) sent on the PDCCH is defined. Depending on the transmission direction, different information elements are sent. As is stated in 3GPP TS 36.212:

5.3.3.1 DCI Formats

5.3.3.1.1 Format 0

DCI format 0 is used for the transmission of UL-SCH assignments.

The following information is transmitted by means of the DCI format 0:
Flag for format0/format1A differentiation—1 bit
Hopping flag—1 bit
Resource block assignment and hopping resource allocation—┌ log₂(N_{RB}^{UL}(N_{RB}^{UL}+1)/2)┐ bits
   For PUSCH hopping:
      N_{UL}_{_{—}}ₕₒₚ bits are used to obtain the value of ñ_{PRB}(i) as indicated in subclause [8.4] of [3]
   (┌ log₂(N_{RB}^{DL}(N_{RB}^{DL}+1)/2)┐−N_{UL}_{_{—}}ₕₒₚ) bits provide the resource allocation of the first slot in the UL subframe
   For non-hopping PUSCH:
   (┌ log₂(N_{RB}^{DL}(N_{RB}^{DL}+1)/2)┐) bits provide the resource allocation of the first slot in the UL subframe
Modulation and coding scheme and redundancy version—5 bits
New data indicator—1 bit
TPC command for scheduled PUSCH—2 bits
[Cyclic shift for DM RS—3 bits]
UL index (this field just applies to TDD operation)
CQI request—1 bit

5.3.3.1.2 Format 1

DCI format 1 is used for the transmission of DL-SCH assignments for SIMO operation.

The following information is transmitted by means of the DCI format 1:
Resource allocation header (resource allocation type 0/type 1)—1 bit
Resource block assignment:
   For resource allocation type 0 [3],
      ┌N_{RB}^{DL}/P┐ bits provide the resource allocation
   For resource allocation type 1 [3],
      ┌ log₂(P)┐ bits of this field are used as a header specific to this resource allocation type to indicate the selected resource blocks subset
      1 bit indicates a shift of the resource allocation span
      (┌N_{RB}^{DL}/P┐−┌ log₂(P)┐−1) bits provide the resource allocation
   where the value of P depends on the number of DL resource blocks as indicated in subclause [7.1.1] of [3]
Modulation and coding scheme—5 bits
HARQ process number—3 bits (FDD), 4 bits (TDD)
New data indicator—1 bit
Redundancy version—2 bits
TPC command for PUCCH—2 bits

5.3.3.1.3 Format 1A

DCI format 1A is used for a compact transmission of DL-SCH assignments for SIMO operation.

The following information is transmitted by means of the DCI format 1A:
Flag for format0/format1A differentiation—1 bit
Distributed transmission flag—1 bit
Resource block assignment
Modulation and coding scheme—5 bits
HARQ process number—3 bits (FDD), 4 bits (TDD)
New data indicator—1 bit
Redundancy version—2 bits
TPC command for PUCCH—2 bits

In one non-limiting and exemplary embodiment of this invention it is desirable that all of the parameters (resource allocation elements, which may also be referred to as control information elements, not to be confused with the resource elements shown in FIG. 1B) that are stored for future use (as the persistent allocation) are the same in each of the two PDCCHs (the pair of persistent UL allocations shown in FIG. 4). In another non-limiting and exemplary embodiment the UE 10 may declare an occurrence of a persistent resource allocation if at least one (selected or predetermined) resource allocation element is the same between the two PDCCHs.

An example of one suitable (and non-limiting) implementation is now described.
1. If the UE 10 receives semi-persistent allocation on the PDCCH (e.g., indicated by a special C-RNTI) and the timer 10H is not running, then:
   a. If the UE 10 does not have a semi-persistent UL grant, then the UE 10 stores the relevant (or selected) parameters and starts the timer 10H;
   b. If the UE has a semi-persistent UL grant, then
      i. If the parameters and timing of the PDCCH would not change the existing semi-persistent UL grant, then do nothing (confirms the semi-persistent allocation); else
      ii. If the parameters or the timing of the PDCCH are different from the existing semi-persistent UL grant, then UE 10 considers that semi-persistent UL grant is released and UE 10 stores the relevant (or selected) parameters and starts the timer 10H.
      iii. Alternatively, if the parameters are the same but the timing of the PDCCH is different, then UE 10 considers that the timing of the semi-persistent allocation is changed and stores the new timing (TTI number).
      iv. Alternatively, if the timing of the PDCCH is the same (UE would have a semi-persistent allocation in that TTI) but some parameter (e.g., PRB allocation or TBS) is changed (and the other relevant parameters are the same) then UE 10 considers that the semi-persistent allocation is updated with the new parameter.
2. If the UE 10 receives another semi-persistent allocation (with the same relevant (or selected) parameters) on the PDCCH while the timer is running, then the UE 10 considers the allocation as semi-persistent, stores the rest of the parameters (if not all were selected) and begins using the semi-persistent allocation without another PDCCH (and stops the timer 10H).
3. If the timer 10H expires, the UE 10 discards the stored semi-persistent parameters.
4. If the UE 10 receives another semi-persistent allocation on the PDCCH while the timer 10H is running, but the relevant (or selected) parameters are different, then the UE 10 replaces the stored parameters with the newly received parameters and restarts the timer 10H.

The “timing” of the semi-persistent allocation may be derived from the latter PDCCH, i.e., the timing offset related to the periodicity. This implies that when the UE 10 receives the first semi-persistent allocation, it need not store the time instant. Instead, it only stores the parameters and starts the timer 10H. When the UE 10 receives the second PDCCH it also stores the TTI (or subframe) number (=10*SFN+subframe index, where SFN is the system frame number and subframe index=0, 1, . . . , 9).

FIG. 5 shows an example of a semi-persistent allocation for the case of UL VoIP packet traffic in accordance with the exemplary embodiments of this invention. At the beginning of the talk spurt (following the SR transmitted by the UE 10) two semi-persistent PDCCHs are sent (the first two VoIP packets are allocated using semi-persistent PDCCH). Afterwards the UE 10 is allowed to send the initial transmissions without receiving a new UL grant from the eNB 12. Any needed retransmissions may be handled adaptively (scheduled with PDCCH, as in first retransmission shown in FIG. 5) or non-adaptively (only a NAK is sent from the eNB 12, as in the second retransmission in FIG. 5).

Note that the frequency allocations given in the first and second semi-persistent PDCCHs may be different (assuming that the frequency allocation was not within the selected parameters).

If the first semi-persistent allocation is for some reason lost (not correctly received or responded to by the UE 10), the eNB 12 should detect this fact from an expected but missing UL (e.g., VOIP) packet transmission. In this case the eNB 12 may send another semi-persistent PDCCH. If the second semi-persistent PDCCH is lost, the eNB 12 should again detect this condition. However, sending one more semi-persistent PDCCH would not be sufficient if the timer 10H is set to PS_PERIOD (typically 20 ms for VOIP). In this case then either a forth semi-persistent PDCCH is sent, or the timer 10H can be increased to, for example, 2 times the PS_PERIOD.

Although the exemplary embodiments have been described thus far in the context of the UL, it may also be applied for use in making DL semi-persistent allocations to improve reliability. In the DL direction the UE 10 does not consider the allocation semi-persistent until it has received two (identical or substantially identical) semi-persistent PDCCHs. Afterwards (after receiving the two semi-persistent PDCCHs) the UE 10 attempts to receive the PDSCH (the data channel) blindly without receiving the PDCCH.

Using two PDCCHs for triggering the semi-persistent allocation implies that the probability for false positive detection decreases significantly.

If desired, the PDCCHs may be transmitted using a higher aggregation level, i.e., using more resource elements and thus stronger channel coding, or with higher power.

The exemplary embodiments of this invention may be implemented at least in part by a revision to at least one LTE standard document. For example, a change may be made to subclause 5.4.1 “UL Grant reception” of 3GPP TS 36.321 V8.1.0 (2008-03) Technical Specification 3rd Generation Partnership Project; Technical Specification Group Radio Access Network; Evolved Universal Terrestrial Radio Access (E-UTRA) Medium Access Control (MAC) protocol specification (Release 8). In a first embodiment the subclause may be modified to read as follows:

5.4.1 UL Grant Reception

When the UE has a C-RNTI, Semi-Persistent Scheduling C-RNTI, or Temporary C-RNTI, the UE shall for each TTI:
If the Semi-Persistent Grant Timer expires: discard the stored PDCCH parameters;
If an uplink grant for this TTI has been received on the [PDCCH] for the UE's C-RNTI, Semi-Persistent scheduling C-RNTI or Temporary C-RNTI; or
if an uplink grant for this TTI has been received in a Random Access Response:
Indicate a valid uplink grant and the associated HARQ information to the HARQ entity for this TTI;
If the uplink grant has been received on the PDCCH for the UE's Semi-Persistent C_RNTI (a new persistent grant):
If the Semi-Persistent Grant Timer is running and the PDCCH parameters are the same as those stored:
consider UL grant configured, stop the Semi-Persistent Grant Timer and store the uplink grant and the TTI number (STORED_UL_TTI=CURRENT_TTI).
Else
store the PDCCH parameters and start or restart the Semi-Persistent Grant Timer.
Else, if an uplink grant for this TTI has been configured (CURRENT_TTI−STORED_UL_TTI) mod PS_PERIOD=0)
Indicate a persistent uplink grant, valid for new transmission, and the associated HARQ information to the HARQ entity for this TTI.

NOTE:The period of configured uplink grants is expressed in TTIs.

NOTE:If the UE receives both a grant for its RA-RNTI and a grant for its C-RNTI, the UE may choose to continue with either the grant for its RA-RNTI or the grant for its C-RNTI.

In a second embodiment the subclause may be modified to read as follows:

The UE shall for each TTI:
If an uplink grant for this TTI has been received on the [PDCCH]; or
if an uplink grant for this TTI has been received in a Random Access Response:
Indicate a valid uplink grant and the associated HARQ information to the HARQ entity for this TTI;
if the uplink grant is a new persistent grant (indicated on the [PDCCH]):
if a previous persistent grant with the same parameters has been received within PS_PERIOD:
consider UL grant configured and store the uplink grant and the TTI number (STORED_UL_TTI=CURRENT_TTI).
else
store the parameters.
else, if an uplink grant for this TTI has been configured (CURRENT_TTI−STORED_UL_TTI) mod PS_PERIOD=0) and an uplink grant for this TTI has not been received on the [PDCCH], nor in a Random Access Response:
Indicate a persistent uplink grant, valid for new transmission, and the associated HARQ information to the HARQ entity for this TTI.

NOTE:The period of configured uplink grants is expressed in TTIs.

In the foregoing two versions of subclause 5.4.1 the text that may be added to reflect the exemplary embodiments of this invention is indicated in bold type.

The foregoing exemplary embodiments thus provide several procedures that can beneficially reduce or essentially eliminate the occurrence of false positive persistent UL grants during operation of the wireless communication system In one procedure two identical (or substantially identical) persistent UL grants need to be received by the UE 10 within some predetermined period, such as, e.g., PS_PERIOD or 2*PS_PERIOD, (or more generally a multiple (n) of PS_PERIOD, where n is equal to one, or approximately one, or greater than one) before the UE 10 is allowed to send persistently without receiving an UL allocation. In one case the persistent allocation is triggered by receiving two PDCCHs indicating persistent UL grant with same L1 parameters, while in another case the two persistent UL grants need to be received within, for example, PS_PERIOD. In one case the two persistent UL grants are received within the same TTI, while in another case the two persistent UL grants are received within two separate TTIs. In these embodiments the timer 10H may be set to a value close to PS_PERIOD or 2*PS_PERIOD, for example.

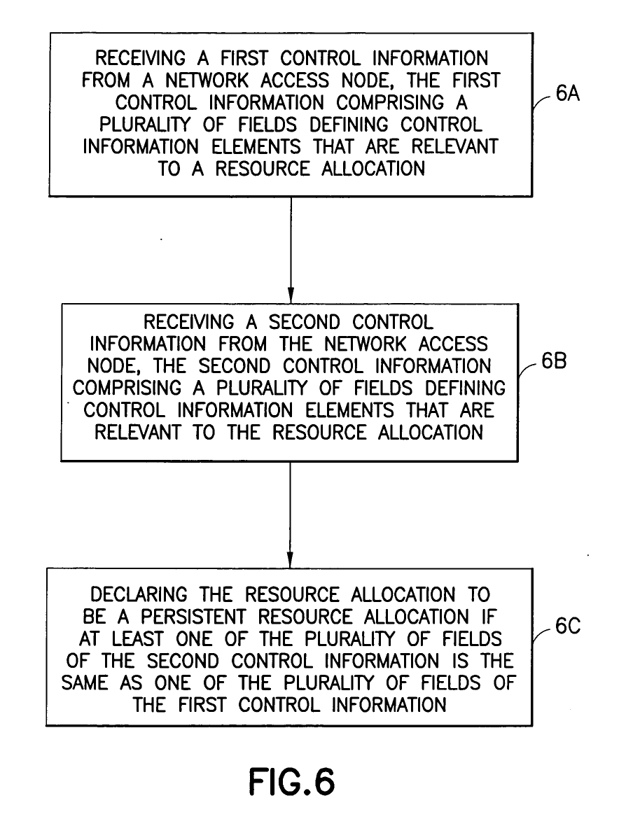

Based on the foregoing it should be apparent that the exemplary embodiments of this invention provide a method, apparatus and computer program product(s) to provide persistent resource allocations to user equipment. In accordance with a method and a result of execution of computer program instructions, and referring to FIG. 6, at Block 6A there is a step of receiving a first control information from a network access node, the first control information comprising a plurality of fields defining control information elements that are relevant to a resource allocation. At Block 6B there is a step of receiving a second control information from the network access node, the second control information comprising a plurality of fields defining control information elements that are relevant to the resource allocation. At Block 6C there is a step of declaring the resource allocation to be a persistent resource allocation if at least one of the plurality of fields of the second control information is the same as one of the plurality of fields of the first control information.

It should be noted that in the foregoing method, and in response to receiving the first control information, there may be a further step of transmitting a first data unit to the network access node using the defined control information elements (an UL transmission).

It should be noted that in the foregoing method, and in response to receiving the first control information, there may be a further step of receiving a first data unit from the network access node using the defined control information elements (a DL transmission).

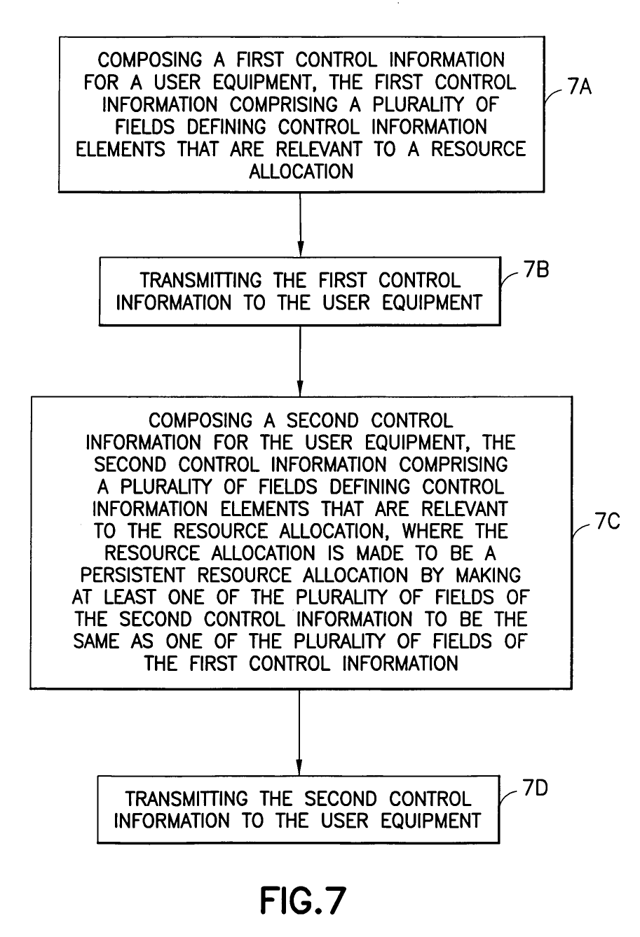

Further in accordance with a method and a result of execution of computer program instructions, and referring to FIG. 7, at Block 7A there is a step of composing a first control information for a user equipment, the first control information comprising a plurality of fields defining control information elements that are relevant to a resource allocation. At Block 7B there is a step of transmitting the first control information to the user equipment. At Block 7C there is a step of composing a second control information for the user equipment, the second control information comprising a plurality of fields defining control information elements that are relevant to the resource allocation. The resource allocation is made to be a persistent resource allocation by making at least one of the plurality of fields of the second control information to be the same as one of the plurality of fields of the first control information. At Block 7D there is a step of transmitting the second control information to the user equipment.

The various blocks shown in FIGS. 6 and 7 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention. For example, at least the DPs 10A, 12A, which may be considered to function as UE and eNB controllers, respectively, may each be embodied at least partially in at least one integrated circuit.

Depending on the level of integration, and by example, one or more of the memory and/or transceiver-related circuitry may be integrated together with the respective controller.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the EUTRAN (UTRAN-LTE) system, it should be appreciated that the exemplary embodiments of this invention are not limited for use with only this one particular type of wireless communication system, and that they may be used to advantage in other wireless communication systems.

Further by example, while the exemplary embodiments have been described in the context of a VoIP application, they may be used in other types of applications wherein it is desired to transmit a stream of packets (data units) using persistent or semi-persistent resource allocations (e.g., video content). The various packets may be logically related, e.g., they are associated with a single ongoing VoIP connection, or they may be logically distinct and unrelated to one another.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
receiving a first control information from a network access node, the first control information comprising a plurality of fields defining control information elements that are relevant to a resource allocation;
receiving a second control information from the network access node, the second control information comprising a plurality of fields defining control information elements that are relevant to the resource allocation; and
declaring the resource allocation to be a persistent resource allocation if at least one of the plurality of fields of the second control information is the same as one of the plurality of fields of the first control information.

2. The method of claim 1, where in response to receiving the first control information, further comprising transmitting a first data unit to the network access node using the defined control information elements.

3. The method of claim 1, where in response to receiving the first control information, further comprising receiving a first data unit from the network access node using the defined control information elements.

4. The method of claim 1, where in response to receiving the first control information, further comprising transmitting a first data unit to the network access node using the defined control information elements, and in response to declaring the resource allocation to be a persistent resource allocation, further comprising transmitting at least one additional data unit to the network access node using the control information elements defined in the received second control information.

5. The method of claim 1, where in response to receiving the first control information, further comprising receiving a first data unit from the network access node using the defined control information elements, and in response to declaring the resource allocation to be a persistent resource allocation, further comprising receiving at least one additional data unit from the network access node using the control information elements defined in the received second control information.

6. The method of claim 1, where the at least one field indicates one of a transport block size, a modulation and coding scheme and a physical resource block allocation.

7. The method of claim 1, where declaring the resource allocation to be a persistent resource allocation occurs only if the first control information and the second control information are received within a predetermined amount of time indicated by a timer.

8. The method of claim 1, where declaring the resource allocation to be a persistent resource allocation occurs only if the first control information and the second control information are received within a period of time indicated by a timer that is a multiple (n) of PS_PERIOD (periodicity of persistent scheduling), where n is equal to about one or greater than one.

9. The method of claim 1, where receiving the first control information and receiving the second control information occurs within one transmission timing interval.

10. The method of claim 1, where receiving the first control information occurs within a first transmission timing interval, and where receiving the second control information occurs within a next transmission timing interval.

11. The method of claim 1, where each of the first control information and second control information comprise information for identifying them as semi-persistent resource allocations.

12. The method of claim 11, where the identifying information comprises a specific semi-persistent scheduling C-RNTI equal to an identification of a user equipment receiving the first control information and the second control information.

13. The method of claim 1, where receiving the first control information occurs after sending a scheduling request to the network access node.

14. The method of claim 1, where in response to declaring the resource allocation to be a persistent resource allocation further comprising storing the control information elements received with the second control information for use during the persistent resource allocation.

15. The method of claim 14, further comprising storing information for identifying a timing offset for the persistent resource allocation.

16. A computer readable medium that stores program instructions, execution of the program instructions resulting in performance of operations comprising:
receiving a first control information from a network access node, the first control information comprising a plurality of fields defining control information elements that are relevant to a resource allocation;
receiving a second control information from the network access node, the second control information comprising a plurality of fields defining control information elements that are relevant to the resource allocation; and
declaring the resource allocation to be a persistent resource allocation if at least one of the plurality of fields of the second control information is the same as one of the plurality of fields of the first control information.

17. The computer readable medium of claim 16, where in response to receiving the first control information, further comprising receiving a first data unit from the network access node using the defined control information elements.

18. The computer readable medium of claim 16, where in response to receiving the first control information, further comprising receiving a first data unit from the network access node using the defined control information elements.

19. The computer readable medium of claim 16, where in response to receiving the first control information, further comprising transmitting a first data unit to the network access node using the defined control information elements, and in response to declaring the resource allocation to be a persistent resource allocation, further comprising transmitting at least one additional data unit to the network access node using the control information elements defined in the received second control information.

20. The computer readable medium of claim 16, where in response to receiving the first control information, further comprising receiving a first data unit from the network access node using the defined control information elements, and in response to declaring the resource allocation to be a persistent resource allocation, further comprising receiving at least one additional data unit from the network access node using the control information elements defined in the received second control information.

21. The computer readable medium of claim 16, where the at least one field indicates one of a transport block size, a modulation and coding scheme and a physical resource block allocation.

22. The computer readable medium of claim 16, where declaring the resource allocation to be a persistent resource allocation occurs only if the first control information and the second control information are received within a predetermined amount of time indicated by a timer.

23. The computer readable medium of claim 16, where declaring the resource allocation to be a persistent resource allocation occurs only if the first control information and the second control information are received within a period of time indicated by a timer that is a multiple (n) of PS_PERIOD (periodicity of persistent scheduling), where n is equal to about one or greater than one.

24. The computer readable medium of claim 16, where receiving the first control information and receiving the second control information occurs within one transmission timing interval.

25. The computer readable medium of claim 16, where receiving the first control information occurs within a first transmission timing interval, and where receiving the second control information occurs within a next transmission timing interval.

26. The computer readable medium of claim 16, where each of the first control information and second control information comprise information for identifying them as semi-persistent resource allocations.

27. The computer readable medium of claim 26, where the identifying information comprises a specific semi-persistent scheduling C-RNTI equal to an identification of a user equipment receiving the first control information and the second control information.

28. The computer readable medium of claim 16, where receiving the first control information occurs after sending a scheduling request to the network access node.

29. The computer readable medium of claim 16, where in response to declaring the resource allocation to be a persistent resource allocation further comprising storing the control information elements received with the second control information for use during the persistent resource allocation.

30. The computer readable medium of claim 29, further comprising storing information for identifying a timing offset for the persistent resource allocation

31. An apparatus, comprising:
a controller coupled with a wireless transmitter, a wireless receiver and a memory, said controller configured to receive a first control information from a network access node, the first control information comprising a plurality of fields defining control information elements that are relevant to a resource allocation and to receive a second control information from the network access node, the second control information also comprising a plurality of fields defining control information elements that are relevant to the resource allocation; said controller further configured to declare the resource allocation to be a persistent resource allocation if at least one of the plurality of fields of the second control information is the same as one of the plurality of fields of the first control information, and to store in the memory control information elements received with the second resource allocation for use during the persistent resource allocation.

32. The apparatus of claim 31, said controller being further configured to also store in the memory information for identifying the timing offset of a periodicity pattern.

33. The apparatus of claim 32, where the information identifying the timing offset is comprised of an identification of a current transmission time interval.

34. The apparatus of claim 31, said controller being configured to respond to receiving the first control information to transmit a first data unit to the network access node using the defined control information elements.

35. The apparatus of claim 31, said controller being configured to respond to receiving the first control information to receive a first data unit from the network access node using the defined control information elements.

36. The apparatus of claim 31, said controller being configured to respond to receiving the first control information to transmit a first data unit to the network access node using the defined control information elements, said controller being further configured to respond to declaring the resource allocation to be a persistent resource allocation to transmit at least one additional data unit to the network access node using the control information elements defined in the received second control information.

37. The apparatus of claim 31, where the at least one field indicates one of a transport block size, a modulation and coding scheme and a physical resource block allocation.

38. The apparatus of claim 31, where said controller declares the resource allocation to be a persistent resource allocation only if the first control information and the second control information are received within a predetermined amount of time indicated by a timer.

39. The apparatus of claim 31, where said controller declares the resource allocation to be a persistent resource allocation only if the first control information and the second control information are received within a period of time indicated by a timer that is a multiple (n) of PS_PERIOD (periodicity of persistent scheduling), where n is equal to about one or greater than one.

40. The apparatus of claim 31, where the first control information and the second control information are received within one transmission timing interval, or within more than one transmission timing intervals.

41. The apparatus of claim 31, where each of the first control information and second control information comprise information for identifying them as semi-persistent resource allocations.

42. The apparatus of claim 41, where the identifying information comprises a specific semi-persistent scheduling C-RNTI equal to an identification of a user equipment receiving the first control information and the second control information.

43. The apparatus of claim 31, where at least said controller is embodied at least partially in at least one integrated circuit.

44. A method, comprising:
composing a first control information for a user equipment, the first control information comprising a plurality of fields defining control information elements that are relevant to a resource allocation;
transmitting the first control information to the user equipment;
composing a second control information for the user equipment, the second control information comprising a plurality of fields defining control information elements that are relevant to the resource allocation, where the resource allocation is made to be a persistent resource allocation by making at least one of the plurality of fields of the second control information to be the same as one of the plurality of fields of the first control information; and
transmitting the second control information to the user equipment.

45. The method of claim 44, where composing the first control information is performed in response to receiving a service request from the user equipment, and where composing the second control information is performed in response to receiving a data unit from the user equipment, the data unit being received in accordance with the control information elements specified in the first control information, and where the second control information is composed so as to include the same or different control information elements as the first control information.

46. The method of claim 44, where the at least one field indicates one of a transport block size, a modulation and coding scheme and a physical resource block allocation.

47. The method of claim 44, where transmitting the second control information occurs in the same transmission time interval as transmitting the first control information.

48. The method of claim 44, where transmitting the second control information occurs in a transmission time interval that follows a transmission time interval in which the first control information was transmitted.

49. The method of claim 44, where transmitting the first control information and the second control information occur within a period of time that is a multiple (n) of PS_PERIOD (periodicity of persistent scheduling), where n is equal to one or greater than one.

50. The method of claim 44, where each of the first control information and the second control information are composed to comprise information for identifying them as semi-persistent resource allocations, where the information comprises a specific semi-persistent scheduling C-RNTI equal to an identification of a user equipment receiving the first control information and the second control information.

51. The method of claim 44, performed as a result of execution of computer program instructions stored in a memory medium that comprises part of an eNodeB.

52. An apparatus, comprising:
a controller coupled with a wireless transmitter and a wireless receiver, said controller configured to compose and transmit a first control information for a user equipment, the first control information comprising a plurality of fields defining control information elements that are relevant to a resource allocation, said controller being further configured to compose and transmit a second control information for the user equipment, the second control information comprising a plurality of fields defining control information elements that are relevant to the resource allocation, where the resource allocation is made to be a persistent resource allocation by making at least one of the plurality of fields of the second control information to be the same as one of the plurality of fields of the first control information.

53. The apparatus of claim 52, where said controller is configured to compose the first control information in response to receiving a service request from the user equipment and to compose the second control information in response to receiving a data unit from the user equipment, the data unit being received in accordance with the control information elements specified in the first control information, where the second control information is composed so as to include the same or different control information elements as the first control information.

54. The apparatus of claim 52, where the at least one field indicates one of a transport block size, a modulation and coding scheme and a physical resource block allocation.

55. The apparatus of claim 52, where said controller transmits the second control information in the same transmission time interval as the first control information is transmitted.

56. The apparatus of claim 52, where said controller transmits the second control information in a second transmission time interval that follows the transmission time interval in which the first control information is transmitted.

57. The apparatus of claim 52, where said controller is configured to transmit the first control information and the second control information within a period of time that is a multiple (n) of PS_PERIOD (periodicity of persistent scheduling), where n is equal to one or greater than one.

58. The apparatus of claim 52, where said controller is configured to compose each of the first control information and the second control information to comprise information for identifying them as semi-persistent resource allocations, where the information comprises a specific semi-persistent scheduling C-RNTI equal to an identification of a user equipment receiving the first control information and the second control information.

59. The apparatus of claim 52, where at least said controller is embodied at least partially in at least one integrated circuit
